(19) United States
(12) Patent Application Publication
(10) Pub. No.: US 2011/0130146 A1
(43) Pub. Date: Jun. 2, 2011

(54) System and method of improving E911 services

(76) Inventors: Jun Liu, San Marcos, CA (US); Hafedh Trigui, Ottawa (CA); Richard Cuthill, Reston, VA (US)

(21) Appl. No.: 12/662,464

(22) Filed: Apr. 19, 2010

Related U.S. Application Data
(63) Continuation-in-part of application No. 12/628,442, filed on Dec. 1, 2009.

(51) Int. Cl. H04W 64/00

(52) U.S. Cl. 455/446

(57) ABSTRACT

An embodiment of the present invention relates to a network management method for improving E911 services. The network management method including determining a location of at least one user in a communications network, creating a coverage map for the communications network based on the determined location of the at least one user in the communications network, and providing the coverage map to an emergency services database. Additionally, the coverage map includes information depicting at least one user in the communications network.

### RELATED U.S. APPLICATION

The present application is a continuation-in-part of U.S. application Ser. No. 12/628,442 entitled “Coverage Hole Detector” and filed on Dec. 1, 2009, the contents of which are fully incorporated by reference herein.

### BACKGROUND OF THE INVENTION

1. FIELD OF THE INVENTION

The present invention relates to improving E911 service in a communications network, and more particularly, to improving E911 services by providing an actual coverage map of mobile subscriber information to emergency services, and by providing a coverage map of mobile subscriber information to emergency services when adaptive sectorization has been performed in the communications network.

2. DESCRIPTION OF THE RELATED ART

FIG. 1 illustrates a conventional implementation of E911 services in a wireless network for implementing both an E911 phase I system and an E911 phase II system.

In an E911 phase I system, the estimated location of a mobile subscriber 102 invoking an emergency call is based on the cell identity of the mobile subscriber 102 (e.g., the phone number of the mobile subscriber). The cell identity of the mobile subscriber 102 is used by the selective router 110 to convert the cell identity of the mobile subscriber 102 into an emergency services number representing an emergency services zone based on cell coverage maps stored within the selective router 110. The mobile subscriber's voice is then relayed to the Public Safety Answering Point (“PSAP”) 112 corresponding to the emergency services zone.

In an E911 phase II system, a mobile subscriber 102 invokes an emergency call which is routed via a radio network controller (“RNC”) 106 to a mobile switching center (“MSC”) 108. The MSC then sends an ORREQ origin request to a mobile positioning center (“MPC”) 118 causing the MPC 118 to send a GPOSREQ position request to a position determining entity (“PDE”) 122. The PDE 112 determines the location of the mobile subscriber according to the GPOSREQ position request and returns the GPOSREQ position request along with the mobile subscriber location to the MPC 118.

Once the MPC receives the mobile subscriber location from the PDE 112, the MPC 118 retrieves routing information for the emergency call from a coordinate routing database (“CRDB”) 120. The CRDB 120 provides a translation between a given position of the mobile subscriber 102 and a string of digits identifying the appropriate emergency services zone (i.e., an emergency services routing key “ESRK”). Once routing information is retrieved the MPC 108 returns the ORREQ origin request to the MSC 108 which then sends the ESRK and the mobile subscriber's voice to a selective router 110. Based on the ESRK, the selective router 110 routes the mobile subscriber's voice to an appropriate PSAP 112.

Additionally, the PSAP 112 is able to query a regional automatic location identifier database (“ALI”) 114 by submitting the received ESRK. The ALI retrieves the mobile subscriber location information, the ESRK, and the mobile subscriber phone number from a wireless national automatic location identified database (“WN/ALI”) 116 which has been updated with the above information by the MPC 118.

In the event that E911 phase II location fixes are not available, the FCC mandates that the system default back to E911 phase I for emergency calls.

In next generation E911 services for voice over IP, the selective router 110 may determine the appropriate emergency services zone based on a cell coverage map, or location estimation of an emergency call. As noted above, the location estimation of an emergency call can be provided by positioning related network elements such as the PDE 112 and MPC 118.

In view of the above, there exists a need for improving the overall accuracy and efficiency of wireless services by improving the cell coverage map stored in the emergency services database such as within the selective router 110 or the CRDB 120.

### SUMMARY OF THE INVENTION

An embodiment of the present invention relates to a network management method for improving E911 services. The network management method including determining a location of at least one user in a communications network, creating a coverage map for the communications network based on the determined location of the at least one user in the communications network, and providing the coverage map to an emergency services database. Additionally, the coverage map includes information depicting at least one user in the communications network.

An embodiment of the present invention relates to a network management method for improving E911 services. The network management method including obtaining a coverage map for a communications network including information depicting at least one user in the communications network, changing configuration parameters of a communication network, updating the obtained coverage map for the communications network after the configuration parameters of the communication network are changed, providing the updated coverage map to an emergency services database, and notifying the emergency services database to use the updated coverage map for providing emergency services to the communications network.

An embodiment of the present invention relates to a network management system for improving E911 services. The network management system includes a coverage map creation unit for creating a coverage map for a communications network and a coverage map providing unit for providing the coverage map to an emergency services database. Additionally, the coverage map includes information depicting at least one user in the communications network.

An embodiment of the present invention relates to a network management system for improving E911 services. The network management system includes a coverage map update unit updating a coverage map for a communications network after configuration parameters of the communications network are changed, a coverage map providing unit for providing the updated coverage map to an emergency services database, and a notification unit informing the emergency services database to use the updated coverage map for providing emergency services to the communications network.

An embodiment of the present invention relates to a non-transitory computer readable medium have recorded thereon a program that when executed by a computer cause the computer to perform a network management method for improving E911 services. The network management method including determining a location of at least one user in a communications network, creating a coverage map for the communications network based on the determined location of the at least one user in the communications network, and providing the coverage map to an emergency services database. Additionally, the coverage map includes information depicting at least one user in the communications network.

An embodiment of the present invention relates to a non-transitory computer readable medium have recorded thereon a program that when executed by a computer cause the computer to perform a network management method for improving E911 services. The network management method including obtaining a coverage map for a communications network including information depicting at least one user in the communications network, changing configuration parameters of a communication network, updating the obtained coverage map for the communications network after the configuration parameters of the communication network are changed, providing the updated coverage map to an emergency services database, and notifying the emergency services database to use the updated coverage map for providing emergency services to the communications network.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a conventional implementation of E911 services in a wireless network.

FIG. 2 illustrates an exemplary implementation of E911 services in a wireless network in accordance with an embodiment of the invention.

FIG. 3 is an example of a predicted coverage map of mobile subscriber information based on assumed statistics.

FIG. 4 is an example of an actual coverage map of mobile subscriber information built on actual mobile subscriber information in accordance with an embodiment of the invention.

FIG. 5 illustrates a flowchart for providing an actual coverage map of mobile subscriber information to emergency services in accordance with an embodiment of the invention.

FIG. 6 illustrates a flowchart for providing an updated coverage map of mobile subscriber information to emergency services in response to adaptive sectorization being performed affecting coverage areas in accordance with an embodiment of the invention.

FIG. 7 illustrates exemplary sectors for a pair of antennas before and after adaptive sectorization affects changes to the vertexes of the coverage areas in accordance with an embodiment of the invention.

FIG. 8A and FIG. 8B illustrate examples of adaptive sectorization affecting a composite coverage area of a coverage area in accordance with an embodiment of the invention.

FIG. 9A and FIG. 9B illustrate examples of adaptive sectorization affecting an individual coverage area of a coverage area in accordance with an embodiment of the invention.

FIG. 10 illustrates a representative network management system as shown in the wireless network of FIG. 2 in accordance with an embodiment of the invention.

### DETAILED DESCRIPTION OF THE INVENTION

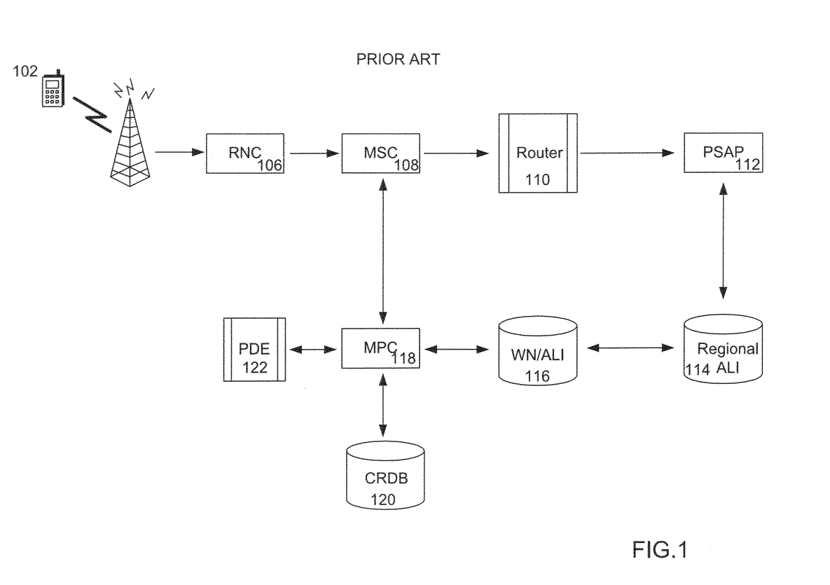

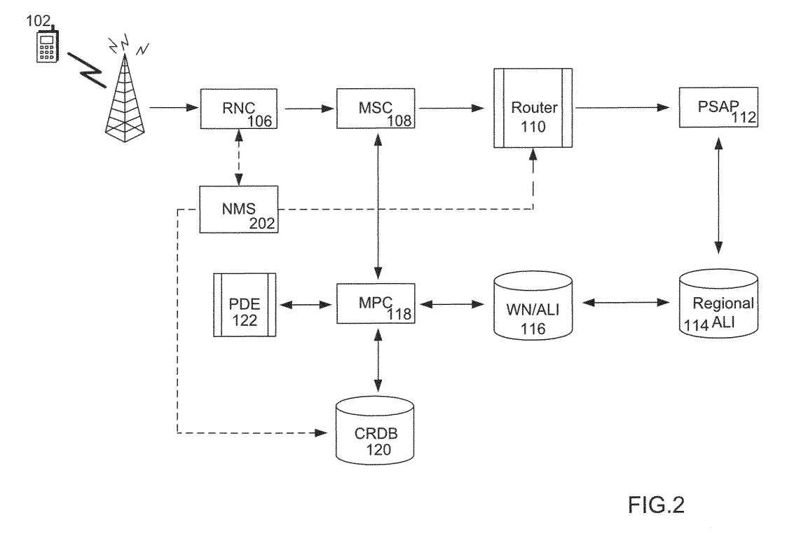

FIG. 2 illustrates an exemplary implementation of E911 services in a wireless network in accordance with an embodiment of the invention. Identical components to those described above with respect to conventional system for implementing E911 services of FIG. 1 will not be described. It should be noted that the present invention is not limited to the embodiment illustrated in FIG. 2, and that one of ordinary skill in the art would find it apparent that the present invention may be differently implemented.

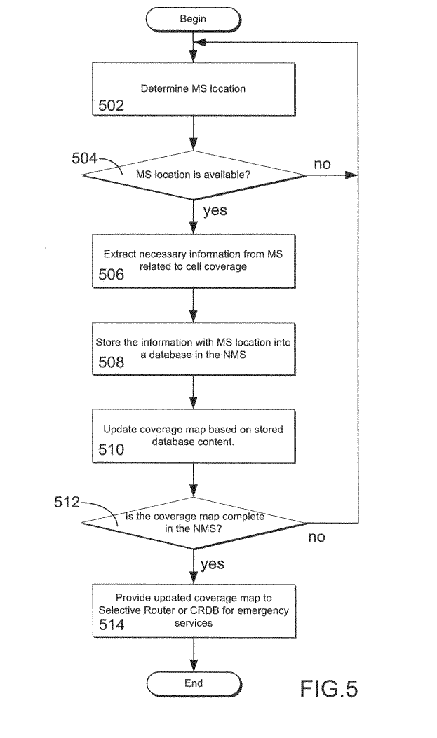

The embodiment of the present invention illustrated in FIG. 2 introduces a network management system (“NMS”) 202 connected to the RNC 106, the selective router 110, and the CRDB 120. The NMS 202 interfaces with a mobile subscriber 102 via the RNC 106 in order to obtain mobile subscriber information. The obtained mobile subscriber information is used by the NMS 202 to provide an actual coverage map of mobile subscriber information to the selective router 110 or the CRDB 120. The actual coverage map provided by the NMS 202 allows the selective router 110 or the CRDB 120 to replace a previously stored predicted coverage map or previously stored actual coverage map, thereby improving the overall accuracy and efficiency of emergency services for a wireless network. Details of providing an actual coverage map of mobile subscriber information will be described below with respect to FIG. 5.

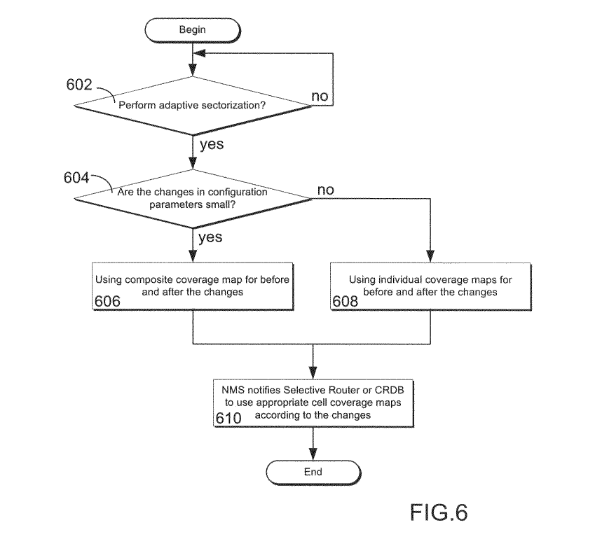

Additionally, the NMS 202 provides an updated coverage map of mobile subscriber information in affected coverage areas to the selective router 110 or the CRDB 120 in response to adaptive sectorization being performed. The updated coverage map provided by the NMS 202 allows the selective router 110 or the CRDB 120 to replace a previously stored coverage map, thereby improving the overall accuracy and efficiency of emergency services for a wireless network. Details of providing an updated coverage map of mobile subscriber information in response to adaptive sectorization being performed will be described below with respect to FIG. 6.

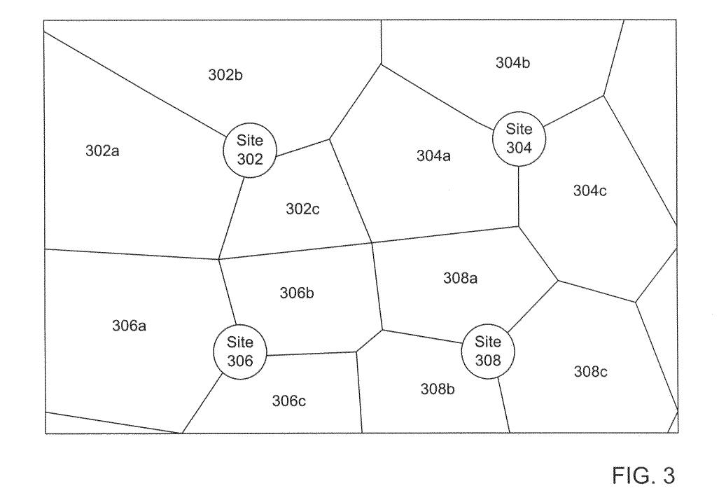

FIG. 3 is an example of a predicted coverage map of mobile subscriber information based on assumed statistics. The predicted coverage map is prepared by an RF planning tool and illustrates a predicted coverage map for tri-sector sites 302, 304, 306, and 308 of a communications network. Each sector (e.g., sectors 302a, 302b, and 302c of tri-sector site 302) of the tri-sector sites 302, 304, 306, and 308 is represented by an irregular shape predicted by the RF planning tool based on, for example, assumptions such as propagation channels, path loss models, user traffics, and subscriber lists.

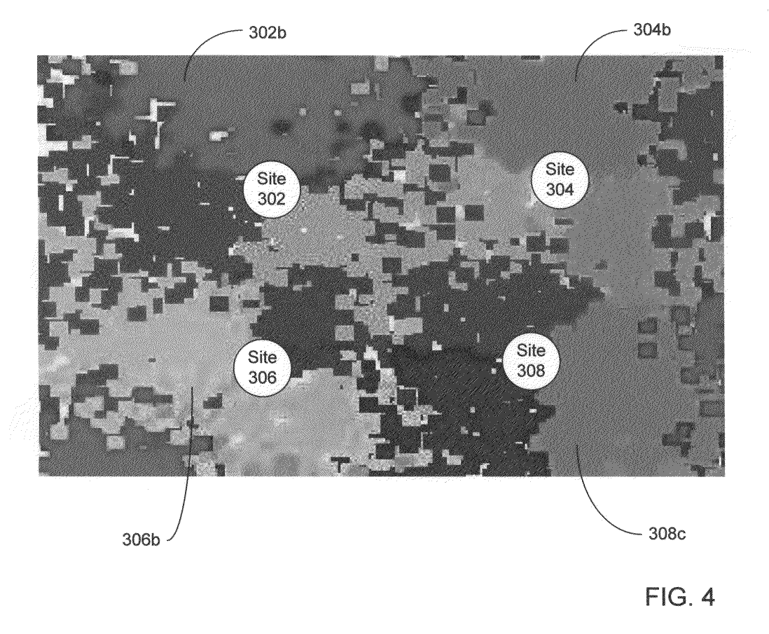

In contrast to FIG. 3, FIG. 4 is an example of an actual coverage map of mobile subscriber information built on actual mobile subscriber information in accordance with an embodiment of the invention. The actual coverage map is prepared by knowing the location of the mobile subscribers and their cell identities, and illustrates an actual coverage map for tri-sector sites 302, 304, 306, and 308 of the wireless network. The actual coverage map is formed by showing the mobile subscribers' real-time locations within their respective serving sectors, thereby providing a more accurate representation of coverage than the predicted map illustrated in FIG. 2. A determination of the locations of the mobile subscribers is beyond the scope of the present disclosure but may be determined by, but not limited to, the method disclosed in co-pending parent application Ser. No. 12/628,442, autonomous GPS, or the combination of the MPC 118 and PDE 122 as disclosed in the background.

FIG. 5 illustrates a flowchart for providing an actual coverage map of mobile subscriber information to emergency services in accordance with an embodiment of the invention. After initialization, at Step 502, the NMS 202 attempts to determine a location of a mobile subscriber. As noted above the determination of the location of the mobile subscriber is beyond the scope of the present disclosure but may be determined by, but not limited to, the method disclosed in co-pending parent application Ser. No. 12/628,442, autonomous GPS, or the combination of the MPC 118 and PDE 122 as disclosed in the background.

At Step 504, the NMS determines if the mobile subscriber's location is available based on the results of the NMS 202 attempting to determine the location of the mobile subscriber at Step 502. If the location of the mobile subscriber is available, (i.e., the NMS is able to determine the location of the mobile subscriber at Step 502), the NMS 202, at Step 506, extracts the necessary information from the mobile subscriber related to determining the actual coverage map. This information may include, but is not limited to, received signal strength, received signal quality, and received noise or interference levels.

After extraction of the necessary information, the extracted information is then stored with the mobile subscriber location into a database accessible in the NMS 202, at Step 508. For example, the database may be, but is not limited to, stored in memory in the NMS 202. At Step 510, the NMS 202 then updates the actual coverage map based on the stored database information.

After update, the NMS 202 determines if the updated actual coverage map is complete at Step 512, and if the actual coverage map is complete, the NMS 202 provides the updated actual coverage map to the selective router 110 or the CRDB 120 at Step 514, thereby improving the overall accuracy and efficiency of emergency services for a communications network. However, if the updated actual coverage map is not complete, the NMS 202 returns to step 502 and determines if a different mobile subscriber location is available.

FIG. 6 illustrates a flowchart for providing an updated coverage map of mobile subscriber information to emergency services in response to adaptive sectorization being performed affecting coverage areas in accordance with an embodiment of the invention. Initially, it should be noted that prior to providing an updated coverage map of mobile subscriber information to emergency services in response to adaptive sectorization being performed affecting coverage areas in accordance with an embodiment of the invention, it is preferred that all coverage maps to be used by the selective router 110 and the CRDB 120 have either been stored therein via an RF planning tool, have been stored therein via the method of providing an actual coverage map of mobile subscriber information as described above with reference to FIG. 5, or the like.

Additionally, it should be noted that providing an updated coverage map of mobile subscriber information to emergency services in response to adaptive sectorization being performed affecting coverage areas is not limited to providing a coverage map of mobile subscribers, and it would be apparent to one of ordinary skill in the art that the present invention can be easily modified for use in a fixed subscriber network or the like.

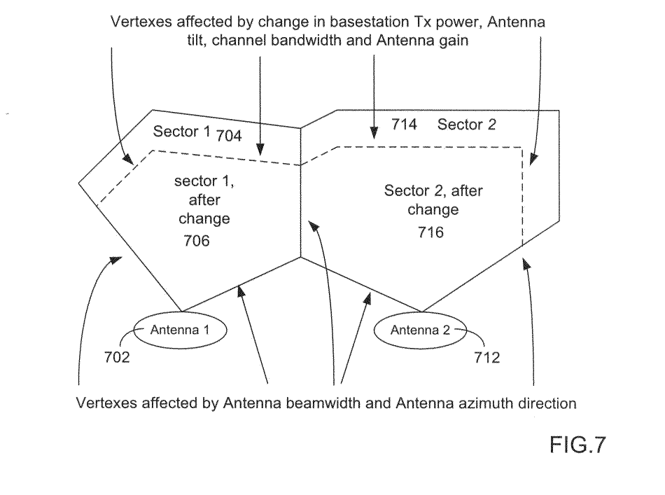

After initialization, at Step 602, it is checked whether or not adaptive sectorization should be performed. A determination of whether or not adaptive sectorization should be performed is beyond the scope of the present disclosure but may be determined by, but not limited to, the methods disclosed in co-pending applications Ser. Nos. 12/580,604, 12/634,057, or 12/718,189, the disclosures of which are herein incorporated by reference. Additionally, the details of performing adaptive sectorization are beyond the scope of the present disclosure but may be performed by, but not limited to, the methods disclosed in co-pending applications Ser. Nos. 12/580,604, 12/634,057, or 12/718,189. An example of performing adaptive sectorization by changing configuration parameters so as to affect the vertexes of coverage areas is illustrated with reference to FIG. 7 below.

If adaptive sectorization is to be performed, the NMS 202, at Step 604, determines whether there are small or large changes in configuration parameters of the antennas or the like at the site in which adaptive sectorization is performed.

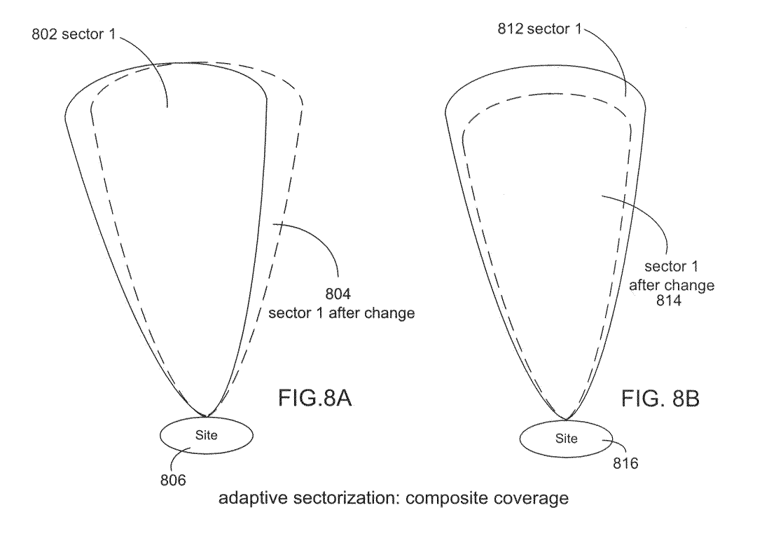

If the changes to the configuration parameters are small, the NMS 202, at Step 606, updates composite coverage maps for the site in which adaptive sectorization is performed and for any other site affected by the adaptive sectorization, and records the updated composite coverage maps in the selected router 110 or the CRDB 120. As previously noted, the composite coverage maps may be planned coverage maps provided by an RF planning tool, or may be provided by the method of providing an actual coverage map of mobile subscriber information as described above with reference to FIG. 5, or the like. Example illustrations of adaptive sectorization affecting a composite coverage area of a coverage area are shown below in FIGS. 8A and 8B. Examples of small changes to the configuration parameters include, but are not limited to, an antenna down tilt change less than or equal to 2 degrees; an antenna beamwidth change less than or equal to 5 degrees; an antenna azimuth direction change less than or equal to 5 degrees; or a BS Tx power change less than or equal to 2 dBm.

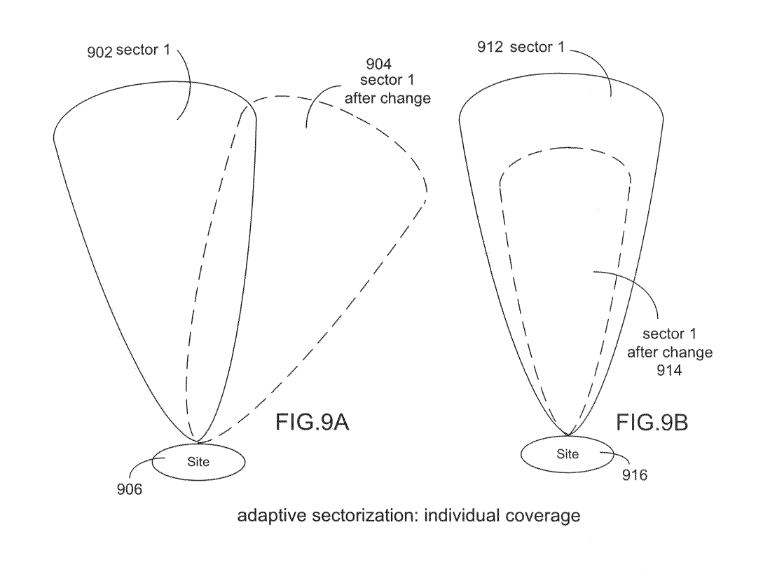

If the changes to the configuration parameters are large, the NMS 202, at Step 608, updates individual coverage maps for the site in which adaptive sectorization is performed and for any other site affected by the adaptive sectorization, and records the updated individual coverage maps in the selected router 110 or the CRDB 120. As previously noted, the individual coverage maps may be planned coverage maps provided by an RF planning tool, or may be provided by the method of providing an actual coverage map of mobile subscriber information as described above with reference to FIG. 5, or the like. Example illustrations of adaptive sectorization affecting an individual coverage area of a coverage area are shown below in FIGS. 9A and 9B. Examples of large changes to the configuration parameters include, but are not limited to, an antenna down tilt change greater than 2 degrees; an antenna beamwidth change greater than 5 degrees; an antenna azimuth direction change greater than 5 degrees; or a BS Tx power change greater than 2 dBm.

After the composite coverage maps or the individual coverage maps are updated in Steps 606 or 608, respectively, the NMS, at Step 610, provides the selective router 110 or the CRDB 120 with the updated composite coverage maps or the updated individual coverage maps, and notifies the selective router 110 or the CRDB 120 to use the appropriate updated coverage map according to the changes as a result of the performed adaptive sectorization, thereby improving the overall accuracy and efficiency of emergency services for a communications network.

FIG. 7 illustrates exemplary sectors for a pair of antennas 702, 712 before and after changes to the vertexes of the coverage areas as a result of changing configuration parameters so as to perform adaptive sectorization. Based on the capacity of the antennas for each sector (e.g. antenna 1 702 for sector 1 704, and antenna 2 712 for sector 714), few or all vertexes of the coverage area could be modified. For example, changing the electrical or mechanical tilt could increase or decrease the sector reach which translates into moving one or more vertexes related to the sector reach. Additionally, if the azimuth beamwidth of the antenna could be adjusted then the lateral vertexes could move to increase or decrease the coverage area. Further, some antennas may control the azimuth pointing direction and, as such, the coverage area for each sector is altered according to a new pointing angle. It should be noted that sector reach would be impacted by basestation transmit power (“BS Tx power”), channel bandwidth, and multicarriers. Finally, it should also be noted that the coverage area could be affected by surrounding sectors.

As noted above, FIG. 7 provides exemplary coverage sectors for a pair Of antennas 702, 712 before and after changes to the vertexes of the coverage area. Specifically, antenna 1 702 has a sector 1 704, and antenna 2 712 has a sector 2 714 before altering the respective vertexes of the sectors. After decreasing the reach of the sectors, antenna 1 has a sector 1 706, and antenna 2 712 has a sector 716. Additionally, FIG. 7 includes the vertexes affected by change in basestation Tx power, antenna tilt, channel bandwidth, and antenna gain; and the vertexes affected by change in antenna beamwidth, and antenna azimuth direction.

FIG. 8A and FIG. 8B illustrate examples of adaptive sectorization affecting a composite coverage area of a coverage area in accordance with an embodiment of the invention. As previously described with reference to Steps 604 and 606 of FIG. 6, composite coverage maps are updated when the changes to the configuration parameters of an antenna are small.

In FIG. 8A, adaptive sectorization is performed for sector 1 802 by changing the azimuth direction of antenna 806. The resulting coverage area for sector 1 after the change 804 is shown with a dotted outline. With a small change, the coverage areas for sector 1 before the change 802 and after the change 804 largely overlap (for example, more than 80% of the coverage areas are common before and after the change). The composite coverage map for sector 1 (which covers the coverage areas for sector 1 before the change 802 and after the change 804) is then provided to and used in the appropriate emergency services database. For example, as previously described with reference to Steps 606 and 610 of FIG. 6, after adaptive sectorization is performed resulting in the composite coverage map for sector 1 (which covers the coverage areas for sector 1 before the change 802 and after the change 804), the NMS 202 updates the composite coverage maps for site 806, records the updated composite coverage maps for site 806 in the selective router 110 or the CRDB 120, and notifies the selective router 110 or the CRDB 120 to use the updated composite coverage maps for site 806.

In FIG. 8B, adaptive sectorization is performed for sector 1 812 by down-tilting antenna at site 816 or changing the beamwidth of antenna 816, or reducing BS Tx power at site 816. The resulting coverage area for sector 1 after the change 814 is shown with a dotted outline. With a small change, the coverage areas for sector 1 before the change 812 and after the change 814 largely overlap (for example, more than 80% of the coverage areas are common before and after the change). The composite coverage map for sector 1 (which covers the coverage areas for sector 1 before the change 812 and after the change 814) is provided to and used in the appropriate emergency services database. For example, as previously described with reference to Steps 606 and 610 of FIG. 6, after adaptive sectorization is performed resulting in composite coverage map for sector 1 (which covers the coverage areas for sector 1 before the change 812 and after the change 814), the NMS 202 updates the composite coverage maps for site 816, records the updated composite coverage maps for site 816 in the selective router 110 or the CRDB 120, and notifies the selective router 110 or the CRDB 120 to use the updated composite coverage maps for site 816.

FIG. 9A and FIG. 9B illustrate examples of adaptive sectorization affecting an individual coverage area of a coverage area in accordance with an embodiment of the invention. As previously described with reference to Steps 604 and 608 of FIG. 6, individual coverage maps are updated when the changes to the configuration parameters of an antenna are large.

In FIG. 9A, adaptive sectorization is performed for sector 1 902 by changing the azimuth direction of antenna 906. The resulting individual coverage area for sector 1 after the change 904 is shown with a dotted outline. With a large change, the coverage areas for sector 1 before the change 902 and after the change 904 significantly differ (for example, less than 80% of the coverage areas are common before and after the change). The individual coverage map for sector 1 after the change 904 is then provided to and used in the appropriate emergency services database. For example, as previously described with reference to Steps 608 and 610 of FIG. 6, after adaptive sectorization is performed resulting in the individual coverage map for sector 1 after the change 904, the NMS 202 updates the individual coverage maps for site 906, records the updated individual coverage maps for site 906 in the selective router 110 or the CRDB 120, and notifies the selective router 110 or the CRDB 120 to use the updated individual coverage maps for site 906.

In FIG. 9B, adaptive sectorization is performed for sector 1 912 by down-tilting antenna 916 or changing the beamwidth of antenna 916, or reducing BS Tx power at site 916. The resulting individual coverage area for sector 1 after the change 914 is shown with a dotted outline. With a large change, the coverage areas for sector 1 912 before and after the change significantly differ (for example, less than 80% of the coverage areas are common before and after the change). The individual coverage map for sector 1 after the change 914 is then provided to and used in the appropriate emergency services database. As previously described with reference to Steps 608 and 610 of FIG. 6, after adaptive sectorization is performed resulting in the individual coverage map for sector 1 after the change 914, the NMS 202 updates the individual coverage maps for site 916, records the updated individual coverage maps for site 916 in the selective router 110 or the CRDB 120, and notifies the selective router 110 or the CRDB 120 to use the updated individual coverage maps for site 916.

With respect to the above examples for adaptive sectorization presented in FIGS. 8A, 8B, 9A and 9B, the NMS updates the coverage map after the change, records the updated coverage map in the emergency services database, and notifies the appropriate emergency services database to use the updated coverage map. It should be apparent that the present invention is not limited to such a configuration and that alternative approaches may be taken. As an example, the coverage maps before and after adaptive sectorization may be pre-determined and stored in an emergency services database; later, when adaptive sectorization is performed, the NMS then notifies the appropriate emergency services database to use an appropriate coverage map based on the performed adaptive sectorization.

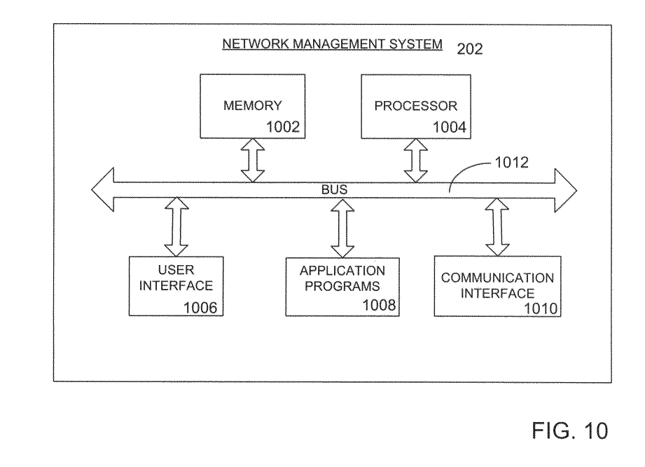

FIG. 10 is a representative Network Management System 202 as shown in the wireless system of FIG. 2. In FIG. 10, the NMS 202 includes a memory 1002, a processor 1004, user interface 1006, application programs 1008, communication interface 1010 and bus 1012.

The memory 1002 can be computer-readable media used to store executable instructions, computer programs, algorithms or the like thereon. The memory 1002 may include a read-only memory (ROM), random access memory (RAM), programmable read-only memory (PROM), erasable programmable read-only memory (EPROM), a smart card, a subscriber identity module (SIM), or any other medium from which a computing device can read executable instructions or a computer program. The term “computer programs” is intended to encompass an executable program that exists permanently or temporarily on any computer-readable medium. The instructions, computer programs and algorithms stored in the memory 1002 cause the NMS 202 to provide E911 services as described above. The instructions, computer programs and algorithms stored in the memory 1002 are executable by one or more processors 1004, which may be facilitated by one or more of the application programs 1008.

The application programs 1008 may also include, but are not limited to, an operating system or any special computer program that manages the relationship between application software and any suitable variety of hardware that helps to make-up a computer system or computing environment of the NMS 202. General communication between the components in the NMS 202 is provided via the bus 1012.

The user interface 1006 allows for interaction between a user and the NMS 202. The user interface 1006 may include a keypad, a keyboard, microphone, and/or speakers. The communication interface 1010 provides for two-way data communications from the NMS 202. By way of example, the communication interface 1010 may be a digital subscriber line (DSL) card or modem, an integrated services digital network (ISDN) card, a cable modem, or a telephone modem to provide a data communication connection to a corresponding type of telephone line. As another example, communication interface 1010 may be a local area network (LAN) card (e.g., for Ethernet™ or an Asynchronous Transfer Model (ATM) network) to provide a data communication connection to a compatible LAN.

Further, the communication interface 1010 may also include peripheral interface devices, such as a Universal Serial Bus (USB) interface, a Personal Computer Memory Card International Association (PCMCIA) interface, and the like. The communication interface 1010 also allows the exchange of information across one or more wireless communication networks. Such networks may include cellular or short-range, such as IEEE 802.11 wireless local area networks (WLANS). And, the exchange of information may involve the transmission of radio frequency (RF) signals through an antenna (not shown).

While an embodiment of the invention has been disclosed, numerous modifications and changes will occur to those skilled in the art to which this invention pertains. The claims annexed to and forming a part of this specification are intended to cover all such embodiments and changes as fall within the true spirit and scope of the present invention.

1. A network management method for improving E911 services comprising:
determining a location of at least one user in a communications network,
creating a coverage map for the communications network based on the determined location of the at least one user in the communications network; and
providing the coverage map to an emergency services database,
wherein the coverage map includes information depicting the at least one user in the communications network.

2. The network management method of claim 1, further comprising:
obtaining information from the at least one user in the communications network,
wherein the coverage map for the communications network is created based on the determined location of the at least one user in the communications network and the obtained information from the at least one user in the communications network.

3. The network management method of claim 2, wherein the obtained information from the at least one user in the communications network includes one or more of a received signal strength, a received signal quality, a received noise level, and a received interference level.

4. The network management method of claim 1,
wherein the created coverage map for the communications network depicts a composite coverage of the at least one user in the communications network, and
wherein the network management method further comprises:
changing configuration parameters of the communication network;
updating the created coverage map for the communications network, said updating occurring after the configuration parameters of the communication network are changed;
providing the updated coverage map to the emergency services database; and
notifying the emergency services database to use the updated coverage map depicting the composite coverage of the at least one user in the communications network for providing emergency services to the communications network.

5. The network management method of claim 4, wherein said changing the configuration parameters of the communications network includes changing a basestation transmission power, an antenna tilt angle, a channel bandwidth, an antenna gain, an antenna beamwidth, or an antenna azimuth direction.

6. The network management method of claim 1,
wherein the created coverage map for the communications network depicts an individual coverage of one of the at least one user in the communications network, and
wherein the network management method further comprises:
changing configuration parameters of the communication network;
updating the created coverage map for the communications network, said updating occurring after the configuration parameters of the communication network are changed;
providing the updated coverage map to the emergency services database; and
notifying the emergency services database to use the updated coverage map depicting the individual coverage of the one of the at least one user in the communications network for providing emergency services to the communications network.

7. The network management method of claim 6, wherein the changing of the configuration parameters of the communications network includes changing a basestation transmission power, an antenna tilt angle, a channel bandwidth, an antenna gain, an antenna beamwidth, or an antenna azimuth direction.

8. A network management method for providing E911 service comprising:
obtaining a coverage map for a communications network including information depicting at least one user in the communications network;
changing configuration parameters of a communication network;
updating the obtained coverage map for the communications network, said updating occurring after the configuration parameters of the communication network are changed;
providing the updated coverage map to an emergency services database; and
notifying the emergency services database to use the updated coverage map for providing emergency services to the communications network.

9. The network management method of claim 8,
wherein the coverage map for the communications network depicts a composite coverage of the at least one user in the communications network, and
wherein said changing the configuration parameters of the communications network includes changing a basestation transmission power, an antenna tilt angle, a channel bandwidth, an antenna gain, an antenna beamwidth, or an antenna azimuth direction.

10. The network management method of claim 8,
wherein the coverage map for the communications network depicts an individual coverage of one of the at least one user in the communications network, and
wherein said changing of the configuration parameters of the communications network includes changing a basestation transmission power, an antenna tilt angle, a channel bandwidth, an antenna gain, an antenna beamwidth, or an antenna azimuth direction.

11. A non-transitory computer readable medium having recorded thereon a network management program that when executed by a computer causes the computer to perform a network management method for improving E911 services comprising:
determining a location of at least one user in a communications network,
creating a coverage map for the communications network based on the determined location of the at least one user in the communications network; and
providing the coverage map to an emergency services database,
wherein the coverage map includes information depicting the at least one user in the communications network.

12. The non-transitory computer readable medium of claim 11,
wherein the network management method further comprises:
obtaining information from the at least one user in the communications network, and
wherein the coverage map for the communications network is created based on the determined location of the at least one user in the communications network and the obtained information from the at least one user in the communications network.

13. The non-transitory computer readable medium of claim 12, wherein the obtained information from the at least one user in the communications network includes one or more of a received signal strength, a received signal quality, a received noise level, and a received interference level.

14. The non-transitory computer readable medium of claim 11,
wherein the created coverage map for the communications network depicts a composite coverage of the at least one user in the communications network, and
wherein the network management method further comprises:
changing configuration parameters of the communication network;
updating the created coverage map for the communications network, said updating occurring after the configuration parameters of the communication network are changed;
providing the updated coverage map to the emergency services database; and
notifying the emergency services database to use the updated coverage map depicting the composite coverage of the at least one user in the communications network for providing emergency services to the communications network.

15. The non-transitory computer readable medium of claim 14, wherein said changing the configuration parameters of the communications network includes changing a basestation transmission power, an antenna tilt angle, a channel bandwidth, an antenna gain, an antenna beamwidth, or an antenna azimuth direction.

16. The non-transitory computer readable medium of claim 11,
wherein the created coverage map for the communications network depicts an individual coverage of one of the at least one user in the communications network, and
wherein the network management method further comprises:
changing configuration parameters of the communication network;
updated the created coverage map for the communications network, said modifying occurring after the configuration parameters of the communication network are changed;
providing the updated coverage map to the emergency services database; and
notifying the emergency services database to use the updated coverage map depicting the individual coverage of the one of the at least one user in the communications network for providing emergency services to the communications network.

17. The non-transitory computer readable medium of claim 16, wherein said changing the configuration parameters of the communications network includes changing a basestation transmission power, an antenna tilt angle, a channel bandwidth, an antenna gain, an antenna beamwidth, or an antenna azimuth direction.

18. A non-transitory computer readable medium having recorded thereon a network management program that when executed by a computer causes the computer to perform a network management method for improving E911 services comprising:
obtaining a coverage map for a communications network including information depicting at least one user in the communications network;
changing configuration parameters of a communication network;
updating the obtained coverage map for the communications network, said modifying occurring after the configuration parameters of the communication network are changed;
providing the updated coverage map to an emergency services database; and
notifying the emergency services database to use the updated coverage map for providing emergency services to the communications network.

19. The non-transitory computer readable medium of claim 18,
wherein the coverage map for the communications network depicts a composite coverage of the at least one user in the communications network, and
wherein said changing the configuration parameters of the communications network includes changing a basestation transmission power, an antenna tilt angle, a channel bandwidth, an antenna gain, an antenna beamwidth, or an antenna azimuth direction.

20. The non-transitory computer readable medium of claim 18,
wherein the coverage map for the communications network depicts an individual coverage of one of the at least one user in the communications network, and
wherein said changing the configuration parameters of the communications network includes changing a basestation transmission power, an antenna tilt angle, a channel bandwidth, an antenna gain, an antenna beamwidth, or an antenna azimuth direction.
